(19) United States
(12) Patent Application Publication
(10) Pub. No.: US 2008/0268815 A1
(43) Pub. Date: Oct. 30, 2008

(54) Authentication Process for Access to Secure Networks or Services

(75) Inventors: Cherif Jazra, Sunnyvale, CA (US); Jianxiong Shi, Pleasanton, CA (US); Isabel Mahe, Los Altos, CA (US)

Correspondence Address: FENWICK & WEST LLP, SILICON VALLEY CENTER, 801 CALIFORNIA STREET, MOUNTAIN VIEW, CA, 94041, US

(73) Assignee: PALM, INC., Sunnyvale, CA (US)

(21) Appl. No.: 11/740,714

(22) Filed: Apr. 26, 2007

(51) Int. Cl. H04M 1/66

(52) U.S. Cl. 455/411

(57) ABSTRACT

A system (and a method) are disclosed to access to secured services that are located behind a firewall. In one embodiment, the system receives at an authentication server a request to access the secured services. The request includes an identification of a mobile telephony device. The system transmits the identification of a mobile telephony device to a mobile telephone network server. The mobile telephone network server generates and transmits at least one security challenge that is forwarded to the mobile telephony device. In response, the mobile telephony device generates at least one response to the at least one security challenge, which gets forwarded to the mobile telephone network server. The mobile telephone network server notifies the authentication server if the response has been appropriately verified, and if so, the system allows the authentication server to allow access to the secured services, e.g., through an authenticated session.

### BACKGROUND

1. Field of Art

The disclosure generally relates to the field of authentication over a network connection.

2. Description of the Related Art

Access to remote services is an increasingly important task for users working with devices outside of a computing services system that is behind a firewall. The services behind the firewall (i.e., the remote services) are on one or more servers and can be remotely accessed through a virtual private network (VPN). In conventional VPN systems, a user at an end user device, e.g., a personal computer, executes a VPN client application. Within the VPN client application, the user enters in a username, a password and an optional token. The entered data is sent to an authentication server that receives the user information (username, password, and optional token) and authenticates the user accordingly with previously stored authentication records. Once authenticated, an encrypted session is established (e.g., tunneling) between the user device and the secured server that resides behind the authentication server.

A problem with conventional VPN configurations is that it often is inconvenient and cumbersome for those seeking to access the remote services. First, the user is required to remember and enter in a correct username and password each time access to the secured server/remote services is desired. This added step increases the latency in accessing remote services. Further, in order to maintain higher level security, passwords must be changed on a regular basis. This increases complexity for a user with respect to remembering a new password at regular intervals. Moreover, in an effort to ease this burden many users fail to change these passwords or use passwords susceptible hacking or other breaches. These breaches put data at the remote services at risk against malicious forces.

Thus, despite mechanisms such as conventional VPN applications and systems, there continues to be a lack of easy to use, yet highly secured authentication systems and processes. That is, there is a lack of systems and processes to authenticate users for access to remote services quickly, efficiently and securely.

### SUMMARY

One embodiment of a disclosed system (and method) includes access to remote services (or a secured server) using a mobile telephony device and mobile telephony network. The mobile telephony device is configured to include a unique identifier that allows for it to access the mobile telephony network.

Generally, in one embodiment, an access authentication server receives the unique identification of the mobile telephony device and transits that unique identification to a mobile telephony network authentication server. The mobile telephony network authentication server generates a security challenge (one or more) for the mobile telephony device and transmits it to the access authentication server. The access authentication server forwards the security challenge back to the mobile telephony device. When the mobile telephony device receives the security challenge, the mobile telephony device calculates (or generates) a response (one or more corresponding to the number of security challenges) that is transmitted back to the access authentication server. The access authentication server forwards the response to the security challenge to the mobile telephony network authentication server. The mobile telephony network determines whether the response form the mobile telephony device is valid and accordingly notifies the access authentication server. If the response was valid, the access authentication server establishes a secured, e.g., an authenticated session for access to the secured server. Alternatively, if the response was invalid, the access authorization server denies access to the secured server.

In one embodiment, the mobile telephony device is configured to communicate with, for example, a personal computing system (or device). The personal computing device attempts to access the secured server through a secured configuration such as a virtual private network (VPN) application. In this embodiment, the personal computing device communicatively couples the access authentication server using an Internet protocol (IP). The personal computing device then relays information, such as the identification of the mobile telephony devices and the security challenge and response between the mobile telephony device and the access authentication device. Thus, the mobile telephony device does not need to be connected with the mobile telephony network in order for the authentication process to occur.

In an alternative embodiment, the mobile telephony device directly attempts a secured connection, for example through a VPN application operating on the mobile telephony device. In this embodiment, the mobile telephony device attempts to connect with the secured server through a mobile telephone data service such as General Packet Radio Service (GPRS), Enhanced Data rate for Global Evolution (EDGE), or High Speed Download Packet Access (HSDPA). However, prior to connecting to the secured server, the mobile telephony device is authorized through the access authorization service as previously described.

The disclosed embodiments provide for highly secured authenticated access to servers (or systems) without the need for an additional user identification or password. Moreover, the configuration provides a cost effective, secured authentication system without having to build an additional authentication infrastructure.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. (Figure) 1 illustrates one embodiment of an architecture for access to remote services.

FIG. 2 illustrates one embodiment of an access process using extensible authentication protocol (EAP)-subscriber identity module (SIM) over a wireless local area network link. FIG. 3 illustrates one embodiment of an access process using EAP-SIM over a cellular (or mobile telephone service) network.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Architectural Overview

FIG. 1 illustrates one embodiment of an architecture for access to remote services. The architecture includes a user (or client) 110 system, a remote services (or secured server) system 122, and a mobile telephony network services system (or mobile telephony network authentication server) 140. As will be further described herein, the user system 110, remote services system 122, and the mobile telephony services system 140 are communicatively coupled together, for example through a wired and/or a wireless system.

Further in describing the architecture, the user system 110 includes a mobile telephony device 105 and optionally includes a companion device 115. The mobile telephony device 105 is configured to communicatively couple the optional companion device 115 wirelessly (e.g., Bluetooth or IEEE 802.11) and/or wired (e.g., USB or Firewire).

The mobile telephony device 105 includes conventional processing technology, including, for example, a processor, a memory, and an operating system. The mobile telephony device 105 may be, for example, a mobile telephone (or cellular phone) or a smart phone (e.g., a PALM TREO™ or other handheld mobile computing device with telephone functionality). In one embodiment, the mobile telephony device 105 incorporates a unique identifier to identify the mobile telephony device 105 to a specific mobile telephony network. The unique identifier can be incorporated directly into the telephone, e.g., as with Code Division Multiple Access (CDMA) type mobile telephony networks, or can incorporate a Subscriber Identity Module (SIM) card, e.g., as with Global System for Mobile communication (GSM), Universal Mobile Telecommunications System (UMTS) type mobile telephony networks. It is noted that the principles disclosed herein also apply to CDMA systems that use SIM-type cards, for example, Re-Usable Identification Modules (R-UIM).

The companion device includes conventional processing technology including, for example, a processor, a memory and an operating system. The companion device 115 in one embodiment is a mobile telephony peripheral device that is configured to be an extension of services and operation of the mobile telephony device 105. For example, the companion device 115 is configured to have a form factor that includes a large screen interface than a mobile telephony device 105 and includes a full size keyboard that allows for the user finger to be fully engaged in a home position on the keyboard (e.g., the A-S-D-F and J-K-L-; keys). In addition, the companion device 105 includes an “instant on” state that allows for immediate processing on the device without any delay of waiting for the system to get into a “ready state” (e.g., because the relevant aspects of the operating system remains loaded and present in memory). As such, mobile telephony directed applications such as email or phone books can be quickly exchanged between the mobile telephony device 105 and the companion device 115 for immediate processing, yet have ease of interaction due to its larger size and interfaces. Alternatively, the companion device 115 may be a personal computer (e.g., a notebook, laptop, a desktop, or a workstation computer) that communicatively can couple the mobile telephony device 105.

The remote services system 122 includes an access authentication server 120 and a secured computing environment (or services or system) 130 that are separated by a firewall 135. The access authentication server 120 is configured to include an application that determines whether remote users, e.g., 110, are verified as having authorization to gain secured access behind the firewall 135 to the secured computing environment 130. The secured computing environment 130 includes one or more secured server computers 145, a secured network 155, one or more computing devices 165, and associated computing and network services that communicatively couple the secured server computers 145 through the secured network 155. In one embodiment, an example of remote service system 122 includes a corporation, government, or education (or other entity) intranet system.

The mobile telephony services system 140 is part of the mobile telephony network. The mobile telephony services system 140 includes one or more servers that authenticate mobile telephony devices, e.g., 105, prior to allowing those mobile telephony devices access to the mobile telephony network (e.g., to make and receive telephone calls). Examples of a mobile telephony network include AT&T, ORANGE, VERIZON, and SPRINT.

In one general embodiment, the architecture is configured so that the user 110 may seek to access the secured computing environment 130 of the remote services system 122. Accordingly, the user executes a virtual private network (VPN) application on the mobile telephony device 105 or the optional companion device 115. The VPN application incorporates the unique identifier of the mobile telephony device 105 and transmits this information to the access authorization server 120. The access authorization server 120 transmits the unique identifier to the mobile telephony services system 140 to authenticate the user.

The mobile telephony services system 140 generates a security challenge for the unique identifier. The security challenge is transmitted back to the access authorization server 120 a security challenge. The access authorization server 120 transmits the security challenge to the user system 110. The mobile telephony device 105 receives the security challenge and transmits a response back to the access authorization server 120, which forwards it onto the mobile telephony services system 140. In this configuration, the mobile telephony device 105 need not be connected through the mobile telephony network with the mobile telephony services system 140. Alternatively, the security challenge/response configuration can be conducted directly between the mobile telephony device 105 and the mobile telephony services system 140, e.g., though the mobile telephony network, without using the access authorization server 120 as an intermediary for this portion of the process. In addition, it is noted that once the mobile telephony device 105 is authenticated, the companion device 115 can be authenticated for access to the remote services system 122 courtesy of its communication pairing with the mobile telephony device 105.

The mobile telephony services system 140 checks the response to the security challenge with what it expects to receive and transmits a notification to the access authorization server 120 as to whether there is a match (thus, suggesting authorization) or no match (thus, suggesting no authorization). Based on what is received, the access authorization server 120 either establishes a secured session between the user system 110 and the secured computing environment 130 (when there is a match) or denies access to the secured computing environment 130 (no match).

An advantage of the disclosed configuration is that the unique identifier of the mobile telephony device is leveraged to provide an authentication mechanism that can eliminate the need for a user to remember and enter in a user identification and/or password to access a secured computing environment. Further, because the unique identifier is unique to the user and typically is know only to the mobile telephony services system there is additional protection in terms of preventing loss of user identification and/or password information. Moreover, if the unique identifier is misplaced or stolen access from it can be cancelled directly from the mobile telephony services system thereby eliminating access to those secured computing systems that are authenticated through it. Additional advantages and benefits will be seen from the example use cases that are further disclosed herein.

### FIRST EXAMPLE USE CASE

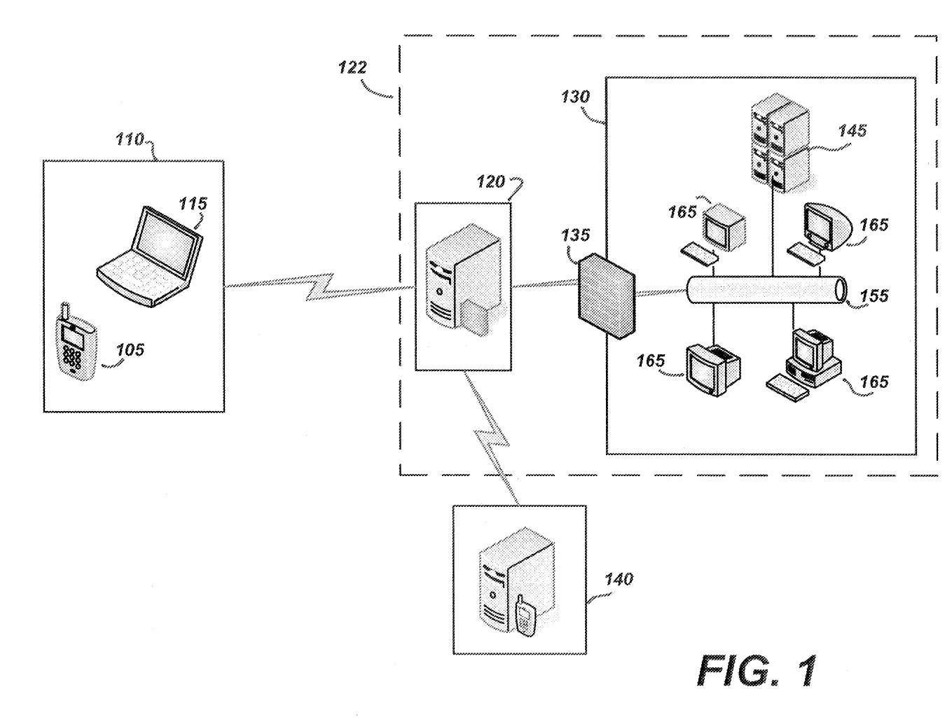

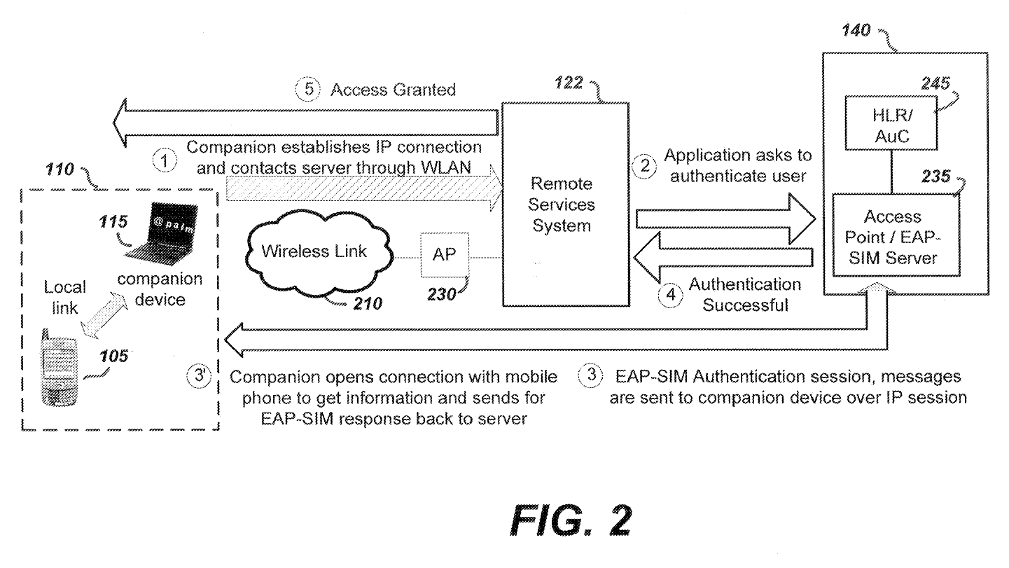

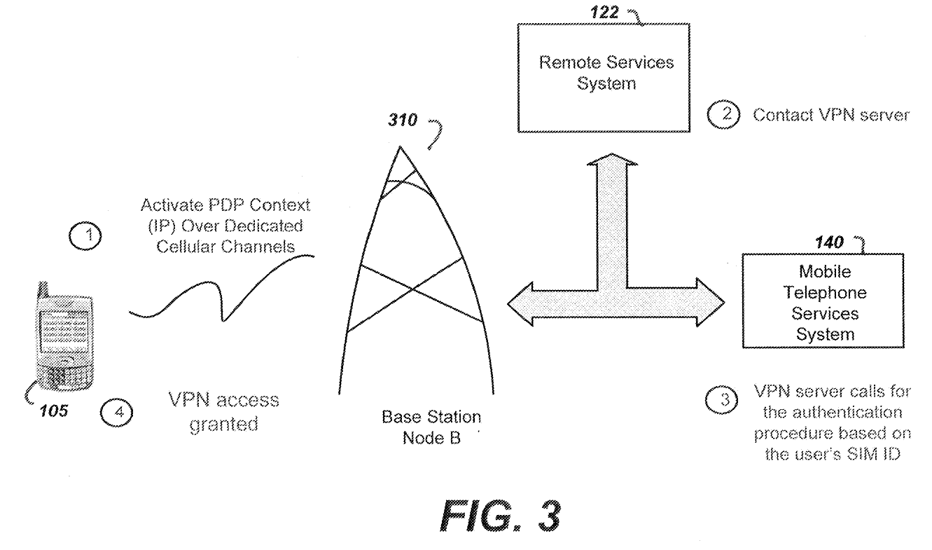

FIG. 2 illustrates one example embodiment of an access process using extensible authentication protocol (EAP)-subscriber identity module (SIM) over a wireless local area network link. This example embodiment is described in a context of attempting access to the secured network environment 130 in the remote services system 122 through the companion device 115.

The process starts (circle 1) with the companion device 115 establishing an Internet protocol (IP) connection with the access authentication server 120 (not shown) of the remote services system 122, for example, through a wireless local area network 210 (including relevant wireless network access points (AP) 220). In one embodiment, the companion device 115 executes (launches) a virtual private network (VPN) application that does not require a user identification (ID) and password. Rather, the VPN application in this embodiment is communicatively coupled with the mobile telephony device 105. The VPN application obtains a SIM identifier from the mobile telephony device 105 and transmits that SIM identifier to the access authentication server 120.

The access authentication server 120 receives the SIM identifier. An access authorization application communicatively couples the mobile telephony services system 140 to request (circle 2) authentication of the user by the mobile telephony services system 140. The mobile telephony services system 140 includes an Extensible Authentication Protocol Method for Subscriber Identity Module (EAP-SIM) server 235 and an HLR server 245. The EAP-SIM server 235 provides authentication and session key distribution using, for example the unique identifier of the SIM. The HLR server 245 includes subscriber information and part of the mobile information that allows calls to be routed to the mobile subscriber. The HLR server 245 stores mobile telephony device information such as the International Mobile Subscriber Identity (IMSI), Mobile System International Subscriber Identity Number (MS ISDN), Vistors' Location Register (VLR) address, and subscriber data on supplementary services.

The EAP-SIM server 235 communicates with a Home Location Register (HLR) server 245 to generate one or more triplets for the SIM associated with the mobile telephony device 105. The HLR server 245 generates the triplets to include, for example, {SECURITY CHALLENGE, EXPECTED RESPONSE, CIPHERKEY}. The HLR server 245 transmits the generated triplets to the EAP-SIM server 235. The EAP-SIM server 235 receives the triplets and stores the triplets information with the corresponding SIM identifier. The EAP-SIM server 235 then transmits only the security challenge (challenge) to the access authentication server 120. It is noted that one or more security challenges may be transmitted depending on the level of security desired. For example, the EAP-SIM server 245 may transmit more than one challenge when higher security levels are desired.

The access authentication server 120 receives the security challenge (or challenges) and transmits it to the companion device 115 (circle 3). The companion device 115 communicates the challenge to the mobile telephony device 105. A SIM card in the mobile telephony device 105 reviews the challenge and calculates (or generates) a response to the challenge and transmits that response back to the companion device 115 (circle 3′). The companion device 115 transmits the response to the security challenge back to the access authentication server 120. The authentication server 120 transmits the response to the EAP-SIM server 235 in the mobile network services system 140. The EAP-SIM server 235 compares the received response with the expected response in the stored triplet corresponding to the identified SIM.

Depending on whether there is a match, the EAP-SIM server 235 notifies the access authorization server 120 as to whether the user is verified (match) or not verified (no match). If the user is not verified, the access authorization server 120 blocks or terminates access to the secured computing environment 130. If the user is verified (successful authorization, circle 4), the access authorization server 120 grants access to the secured computing environment 130 (circle 5). In particular, the authorization server 120 establishes a secured network connection with the secured computing environment 130, e.g., an established VPN connection.

It is noted that is this example embodiment, the mobile telephony device 105 does not require a mobile telephony network connection in order for the authentication process to occur. Accordingly, in one embodiment, an application programming interface (API) or an applet on the mobile telephony device 105 is configured to receive the challenge and communicate with the SIM mechanism in order to generate the response that gets transmitted back to the companion device 115 for transmission through the IP connection. Hence, the process has flexibility to provide authentication services without requiring an active mobile telephony network connection.

### SECOND EXAMPLE USE CASE

In some configurations, the user may execute a VPN application directly through the mobile telephony device 105 rather than through the companion device 115. In such configurations, the mobile telephony device 105 can be authorized for access to the secured computing services 130. To that extent, FIG. 3 illustrates one embodiment of an access process using EAP-SIM over a cellular (or mobile telephone service) network.

In this access process, the mobile telephony device 105 activates a policy decision point (PDP) over a dedicated mobile telephony channel, for example, using a EAP-SIM protocol above an existing IP connection (circle 1). This is a first level authentication between the mobile telephony device 105 and the mobile telephony services system 140.

Once the mobile telephony device 105 establishes a connection with the mobile telephony network, e.g., with the network base station node B 310 in this example, the mobile telephony device 105 launches a VPN application that includes the unique identification information (the SIM identifier). The VPN application uses the data services of the mobile telephony network to contact the access authorization server 120 to seek access to the secured computing services 130 (circle 2). Examples of the data services in the mobile telephony network include, for example, General Packet Radio Service (GPRS), Enhanced Data rate for Global Evolution (EDGE), High Speed Download Packet Access (HSDPA).

Once the access authorization server 120 receives the access request from the VPN application of the mobile computing device 105, it begins the authorization process using the SIM identification. In particular, another authentication session is established and managed by the EAP-SIM server 235 of the mobile telephony services system 140 (circle 3). In particular, EAP-SIM server 235 communicates with the HLR server 245 to receive the one or more triplets. The EAP-SIM server 235 stores the triplets information with the SIM identification. The EAP-SIM server 235 transmits only the security challenge back to the mobile telephony device via the access authorization server 120 over the data services of the mobile telephony network connection. As with the previous example, the mobile telephony device 105 captures the EAP-SIM message and computes the necessary responses that are transmitted back through the data services connection to the EAP-SIM server 235 via the access authorization system 230.

Depending on whether there is a match, the EAP-SIM server 235 notifies the access authorization server 130 at the remote services system 122 as to whether the user is verified (match) or not verified (no match). If the user is not verified, the access authorization server 120 blocks or terminates access to the secured computing services 130. If the user is verified (successful authorization, circle 4), the access authorization server 120 grants access to the secured computing services 130 of the remote services system 122. In particular, the authorization server 120 establishes a secured network connection with the secured computing services 130, e.g., an established VPN connection.

The example embodiments in FIGS. 2 and 3 illustrate a highly secured authentication process to access secured computing resources (or systems) without the need for any additional user identification or password. The configuration is structured to minimize user interaction, but without sacrificing security. Moreover, the configuration provides a cost effective, secured authentication system without having to build an additional authentication infrastructure.

It is noted that some portions of above description describe the embodiments in terms of processes that use or operate on information. These descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for an authentication process that is independent of user involvement to access a secure network or service through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for accessing secured computing services, the method comprising:
receiving at an authentication server an identification of a mobile telephony device;
transmitting the identification of a mobile telephony device to a mobile telephone network server;
receiving at least one security challenge from the mobile telephone network server;
transmitting to the mobile telephony device the at least one security challenge;
receiving at the authentication server at least one response to the at least one security challenge from the mobile telephony device;
transmitting the at least one response to the at least one security challenge to the mobile telephone network server; and
authenticating a session to access the secured computing services in response to verification of the at least one response from the mobile telephone network server.

2. The method of claim 1, further comprising terminating an attempted access to the server behind the firewall in response to receiving non-verification from the mobile telephone network server.

3. The method of claim 2, further comprising:
coupling communicatively the mobile telephony device with a companion device; and
accessing the secured computing services through the companion device in response to the mobile computing device having been successfully authenticated.

4. The method of claim 1, wherein the authentication server is a virtual private network (VPN) server.

5. The method of claim 1, wherein the identification of the mobile telephony device comprises a subscriber identity module (SIM) identification.

6. The method of claim 5, wherein the mobile telephone network server comprises an Extensible Authentication Protocol Method for Subscriber Identity Module (EAP-SIM) server.

7. The method of claim 6, wherein the receiving the SIM identification, further comprises receiving the SIM identification through a virtual private network (VPN) application executing on a personal computing device and communicatively coupled with the Internet.

8. The method of claim 6, wherein receiving the SIM identification further comprises receiving the SIM identification through a virtual private network (VPN) application executing on the mobile telephony device and communicatively coupled with a mobile telephone network corresponding to the mobile telephone network server.

9. The method of claim 8, wherein the mobile telephone network includes a data service comprised of one of a General Packet Radio Service (GPRS), an Enhanced Data rates for Global Evolution (EDGE), or a High Speed Download Packet Access (HSDPA).

10. In a mobile telephony device, a method to access a server secured behind a firewall, the method comprising:
transmitting a request to establish an authenticated session with the server secured behind the firewall, the request including an identification of a mobile telephony device;
receiving at least one security challenge in response to the request;
transmitting at least one response to the at least one security challenge; and
establishing and authenticated session to access the server secured behind the firewall in response to at least one response to the at least one security challenge being verified.

11. The method of claim 10, further comprising establishing a communication channel with a personal computing device.

12. The method of claim 11, wherein the mobile telephony device is not connected with a mobile telephone network.

13. The method of claim 11, wherein the personal computing device is communicatively coupled with an authentication server over an Internet protocol (IP) connection.

14. The method of claim 10, further comprising executing an authentication application on the mobile telephony device;

15. The method of claim 14, further comprising establishing a data communication link on a mobile telephony network.

16. The method of claim 14, wherein the identification of the mobile telephony device comprises a subscriber identity module (SIM) identification.

17. The method of claim 16, wherein the mobile telephony network includes a data service comprising one of a General Packet Radio Service (GPRS), an Enhanced Data rate for Global Evolution (EDGE), or a High Speed Download Packet Access (HSDPA).

18. A system for providing access to a secured server, the system comprising:
a mobile telephony device having a unique device identifier corresponding to a mobile telephony network and configured to transmit that unique device identifier for use in an authentication process;
an access authentication server configured to receive a request to access the secured server, the request including the unique device identifier, and configured to transmit a request to authenticate the unique device identifier; and
a mobile telephony network authentication server configured to receive the request to authenticate the unique device identifier and configured to:
transmit a security challenge for the mobile telephony device;
receive, from the mobile telephony device, a response to the security challenge; and
transmit to the access authentication server verification to authenticate the unique device identifier in response to the response to the security challenge being valid.

19. The system of claim 18, wherein the mobile telephony device is communicatively couples a companion device, the companion device configured to access the secured computing services in response to the mobile computing device having been successfully authenticated.

20. The system of claim 19, further comprising a personal computing device communicatively coupled with the mobile telephony device and communicatively coupled with the access authentication server through an virtual private network (VPN) application.

21. The system of claim 20, wherein the mobile computing device and the access authentication server are configured to transmit the security challenge and response between the mobile telephony network authentication server and the mobile telephony device.
